(19) United States
(12) Patent Application Publication
(10) Pub. No.: US 2006/0208483 A1
(43) Pub. Date: Sep. 21, 2006

(54) Hose connection sleeve

(76) Inventor: Wen-Li Guo, Chang Hua Hsien (TW)

Correspondence Address: CHARLES E. BAXLEY, ESQ., 90 JOHN STREET, THIRD FLOOR, NEW YORK, NY, 10038, US

(21) Appl. No.: 11/204,326

(22) Filed: Aug. 15, 2005

(30) Foreign Application Priority Data
Mar. 18, 2005 (CN) 200510024491.4

(51) Int. Cl. F16L 27/00

(52) U.S. Cl. 285/276; 285/275; 285/272

(57) ABSTRACT

A hose assembly includes a connection sleeve which is rotatably mounted to a connection member which is connected to a hose. The connection sleeve has a first flange extending from an inner periphery thereof and a positioning hole is defined radially through a wall of the connection sleeve. The connection member has a second flange extending from an outer periphery thereof so as to be engaged with the first flange. A positioning groove is defined in the outer periphery of the connection member and a positioning member extends through the positioning hole and is engaged with the positioning groove so that the connection sleeve is rotatable relative to the connection member.

### FIELD OF THE INVENTION

The present invention relates to a hose connection sleeve for allowing the hose and the sleeve to be rotated independently.

### BACKGROUND OF THE INVENTION

A conventional way to connect a watering device such as a sprayer or watering nozzle to a hose is to threadedly connect the watering nozzle to a threaded section on an end of the hose. The user than holds the watering nozzle to water the garden. However, the watering nozzle is fixed to the hose so that the hose is moved with the watering nozzle and the hose could be twisted or bent when watering the garden during the movement of the watering nozzle. Once the hose is twisted, the hose could be broken or the water in the hose is stopped at the twisted area of the hose.

The present invention intends to provide a hose connection sleeve which is rotatable independently from the hose.

### SUMMARY OF THE INVENTION

The present invention relates to a hose assembly that comprises a connection sleeve having a through hole defined axially therethrough so as to receive a connection member, and a first flange extends from an inner periphery of the through hole. A positioning hole is defined radially through a wall of the connection sleeve. The connection member has a passage defined axially therethrough and a second flange extends from an outer periphery thereof. An underside of the first flange is overlapped on the second flange and. A positioning member extends through the positioning hole and is engaged with a positioning groove defined in the outer periphery of the connection member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hose assembly of the present invention;

FIG. 2 is a cross sectional view of the hose assembly of the present invention;

FIG. 3 is a cross sectional view of the hose assembly of the present invention, wherein the positioning member is a spring clip;

FIG. 4 is an exploded view to show another embodiment of the hose assembly of the present invention;

FIG. 5 is a cross sectional view of the embodiment of the hose assembly in FIG. 4 of the present invention, and

FIG. 6 is a cross sectional view to show that the positioning member is a bolt.

### DETAILED DESCRIPTION OF THE PREFERRED EMBODIMENTS

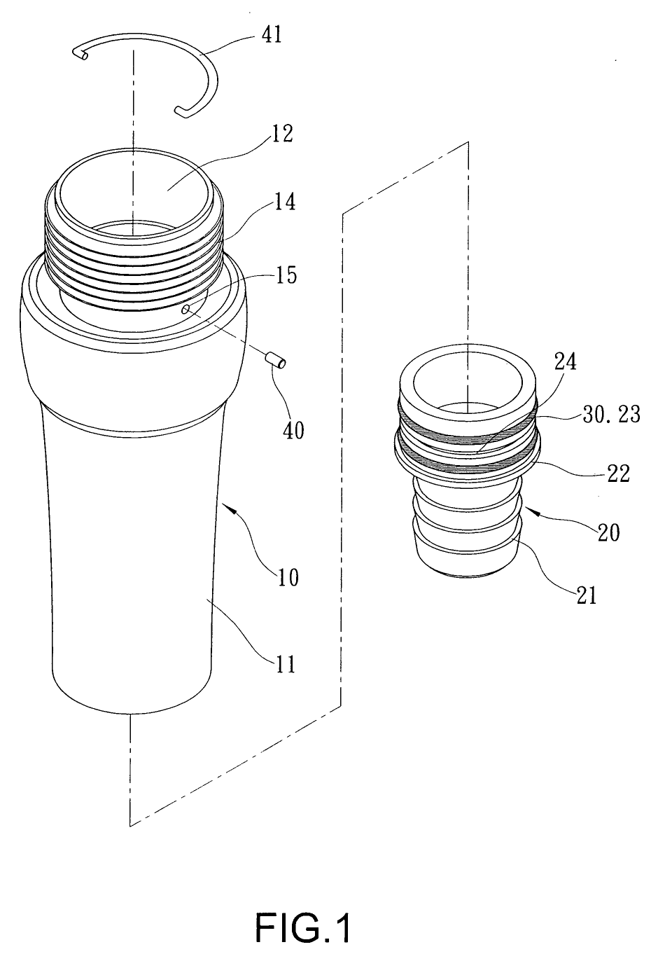

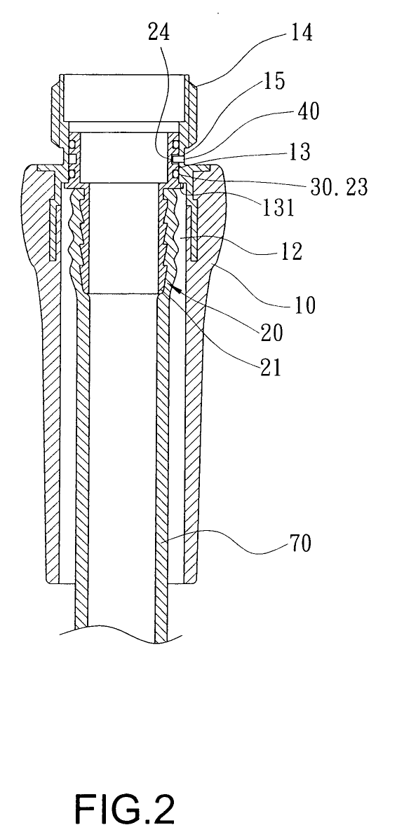

Referring to FIGS. 1 and 2, the hose assembly of the present invention comprises a connection sleeve 10 having a soft handle II and a connection end 14 with outer threaded periphery is connected at an end of the connection sleeve 10. A through hole 12 is defined axially through the connection sleeve 10 and a first flange 13 extends from an inner periphery of the through hole 12. A positioning hole 15 is defined radially through a wall of the connection sleeve 10.

A connection member 20 has a passage defined axially therethrough and a second flange 22 extending from an outer periphery thereof. The connection member 20 includes a connection section 21 to which a hose 70 is connected. Two receiving grooves 23 are defined in the outer periphery of the connection member 20 and seals 30 are engaged with the receiving grooves 23. The connection member 20 is inserted in the through hole 12 in the connection sleeve 10 and an underside 131 of the first flange 13 is overlapped on the second flange 22. The seals 30 prevent leakage between the connection sleeve 10 and the connection member 20. A positioning groove 24 is defined in the outer periphery of the connection member 20.

A positioning member such as a pin 40 extends through the positioning hole 15 and engaged with the positioning groove 24 so that the connection sleeve 10 is rotatable relative to the connection member 20 when needed. A water nozzle which is not shown can be threadedly connected to the connection end 14 and the user may hold the soft handle 11 to watering the garden while the hose 70 is independently rotatable relative to the connection sleeve 10.

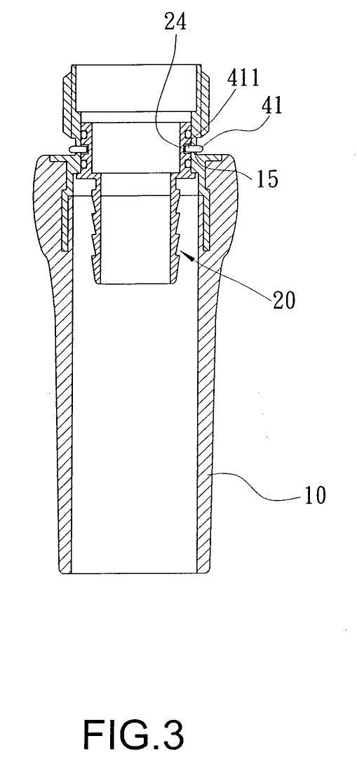

The positioning member can also be a spring clip 41 as shown in FIGS. 1 and 3 and the number of the through holes 15 are two so that two insertions of the spring clip 41 may extend into the two through holes 15.

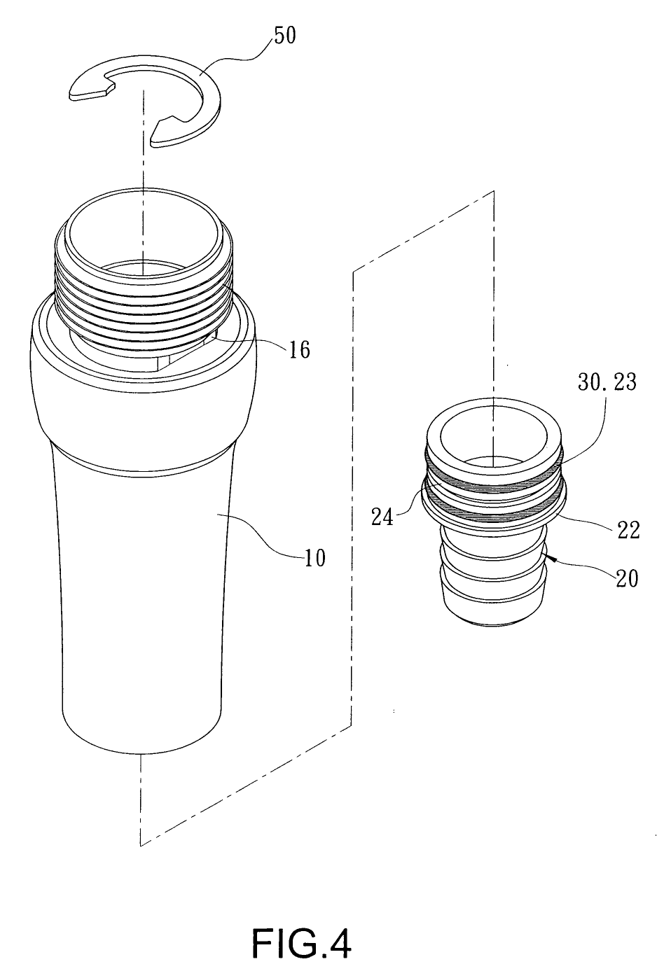

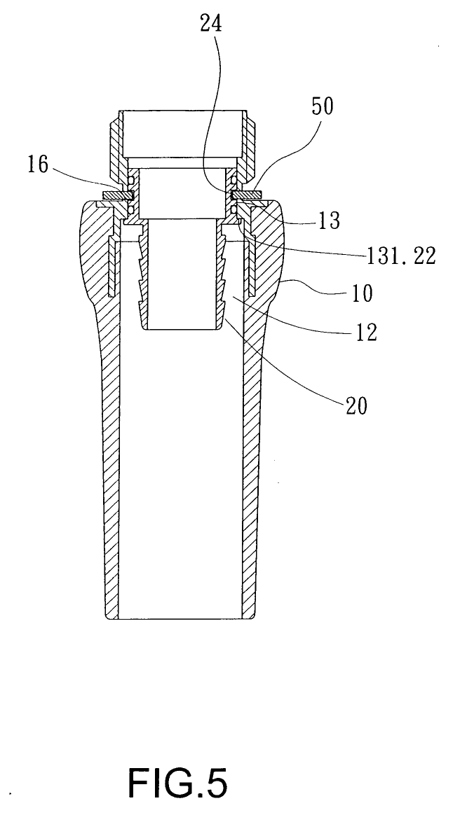

Referring to FIGS. 4 and 5, the positioning hole may includes two ports 16 or slots which are located in opposite to each other in the connection sleeve 10 and the positioning member is a C-clip 50 which includes two insertions at two ends thereof so as to be inserted into the two ports 16.

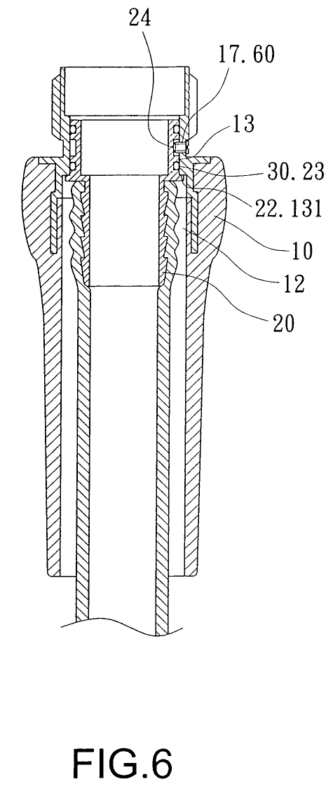

FIG. 6 shows that the positioning hole can also be a threaded hole 17 and the positioning member is a bolt 60.

While we have shown and described the embodiment in accordance with the present invention, it should be clear to those skilled in the art that further embodiments may be made without departing from the scope of the present invention.

What is claimed is:

1. A hose assembly comprising:
a connection sleeve having a through hole defined axially therethrough and a first flange extending from an inner periphery of the through hole, a positioning hole defined radially through a wall of the connection sleeve;
a connection member having a passage defined axially therethrough and a second flange extending from an outer periphery thereof, the connection member inserted in the through hole in the connection sleeve and an underside of the first flange being overlapped on the second flange, a positioning groove defined in the outer periphery of the connection member, and
a positioning member extending through the positioning hole and engaged with the positioning groove.

2. The assembly as claimed in claim 1, wherein the connection sleeve includes a soft handle and a connection end with outer threaded periphery.

3. The assembly as claimed in claim 1, wherein the connection member includes a connection section which is adapted to be connected to a hose.

4. The assembly as claimed in claim 1, wherein the connection member includes receiving grooves defined in the outer periphery thereof and seals are engaged with the receiving grooves.

5. The assembly as claimed in claim 1, wherein the positioning member is a pin.

6. The assembly as claimed in claim 1, wherein the positioning hole is a threaded hole and the positioning member is a bolt.

7. The assembly as claimed in claim 1, wherein the positioning hole includes two ports and the positioning member is a C-clip which includes two insertions at two ends thereof so as to be inserted into the two ports.
